(19) United States
(12) Patent Application Publication
(10) Pub. No.: US 2002/0116648 A1
(43) Pub. Date: Aug. 22, 2002

(54) Method and apparatus for centralized storing and retrieving user password using LDAP

(75) Inventor: Trung M. Tran, Round Rock, TX (US)

Correspondence Address: Duke W. Yee, Carstens, Yee & Cahoon, LLP, P.O. Box 802334, Dallas, TX, 75380, US

(73) Assignee: IBM Corporation

(21) Appl. No.: 09/737,634

(22) Filed: Dec. 14, 2000

(51) Int. Cl. H04L 9/32

(52) U.S. Cl. 713/202; 709/217; 713/150

(57) ABSTRACT

A method for central storage and retrieval of user passwords in a computer network is provided. The method comprises entering network user ID and password information into a central database, and registering each network application and its associated password with a LDAP server. When user ID and password data is received from an application login, the data is encrypted and sent to a secure layer to identify the register application. The data is then sent to the LDAP server where the user password is decrypted and the application's associated password is retrieved. The supplied password is then authenticated and a response is sent from the LDAP server back to the application indicating whether or not the authentication has been verified. Access to the application is granted only if the authentication is indeed verified.

### BACKGROUND OF THE INVENTION

1. Technical Field

The present invention relates to computer network environments. More specifically, the present invention relates to network security measures.

2. Description of Related Art

Lightweight Directory Access Protocol (LDAP) is a protocol that facilitates access to specialized directory servers within a computer network. LDAP provides a referral model which allows client computers to ask a LDAP server a question and be told to contact another server. The contacted server can return any of the requested information which it possesses. In addition, the contacted server returns a list of other servers which might contain the requested information. The LDAP clients, in this case, are responsible for contacting all of the other servers to complete the search request.

LDAP defines a standard method for accessing and updating information in a directory either locally or remotely. It allows a client to develop applications using Application Program Interfaces (APIs), thereby simplifying the process of getting and storing data. The data on a server is organized in a pre-defined hierarchical format. This storage format is called a Directory Information Tree (DIT) and the overall data organization is known as schema.

In today's computer network environments, the network application framework comprises several services including transaction, security, network, directory, print and shared files, distributed object and API. Security service provides the authentication and authorization services to access other services. The access is granted based on the supplied password.

However, passwords are stored in different places for different applications. For example, the Distributed Computing Environment (DCE) stores its principals' passwords in the Registry database, whereas Code Management Version Control (CMVC) stores its users' passwords in the CMVC database.

Therefore, this model has several potential drawbacks. More than one database is needed to store different user passwords from different applications. For example, there might be one database for Mainframe Virtual Machine (VM), one for Lotus, and one for CMVC. It is difficult to maintain and control (add/delete/modify) each database if needed. Each user might have more than one user ID on different applications. In addition, user passwords might be machine dependent (i.e. Lotus uses the local <userid.id> file to store the password).

Therefore, it would be desirable to have a method to centralize the storage and retrieval of user passwords.

### SUMMARY OF THE INVENTION

The present invention provides a method for central storage and retrieval of user passwords in a computer network. The method comprises entering network user ID and password information into a central database, and registering each network application and its associated password with a LDAP server. When user ID and password data is received from an application login, the data is encrypted and sent to a secure layer to identify the register application. The data is then sent to the LDAP server where the user password is decrypted and the application's associated password is retrieved. The supplied password is then authenticated and a response is sent from the LDAP server back to the application indicating whether or not the authentication has been verified. Access to the application is granted only if the authentication is indeed verified.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 depicts a block diagram of a data processing system that may be implemented as a server in accordance with a preferred embodiment of the present invention;

FIG. 3 depicts a block diagram illustrating a data processing system in which the present invention may be implemented; and

FIG. 4 depicts a flowchart illustrating the authentication of application passwords in accordance with the present invention.

### DETAILED DESCRIPTION OF THE PREFERRED EMBODIMENT

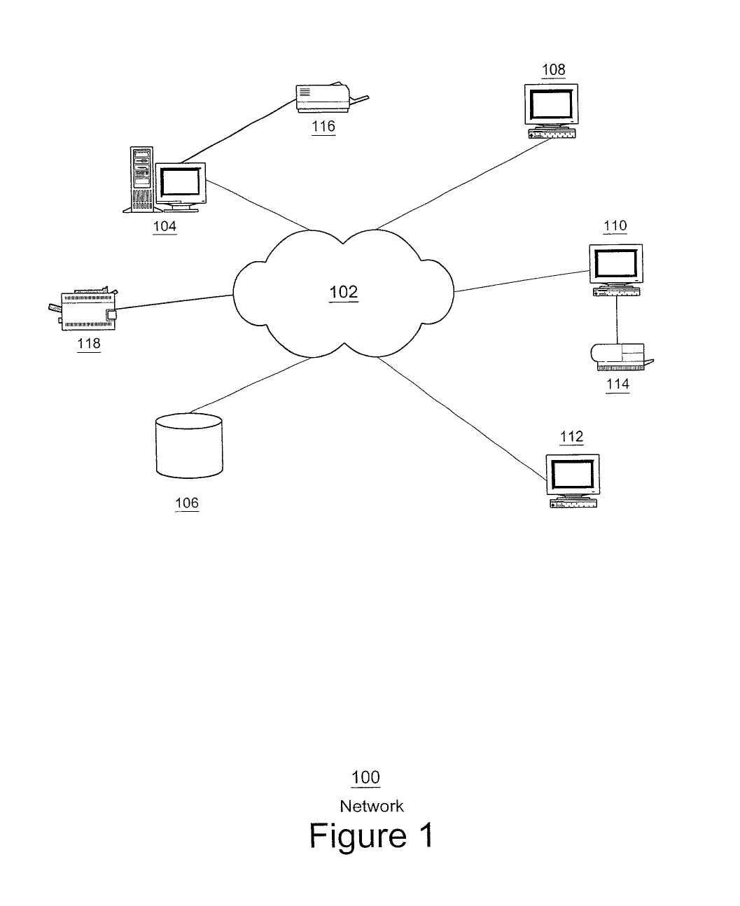

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown.

In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

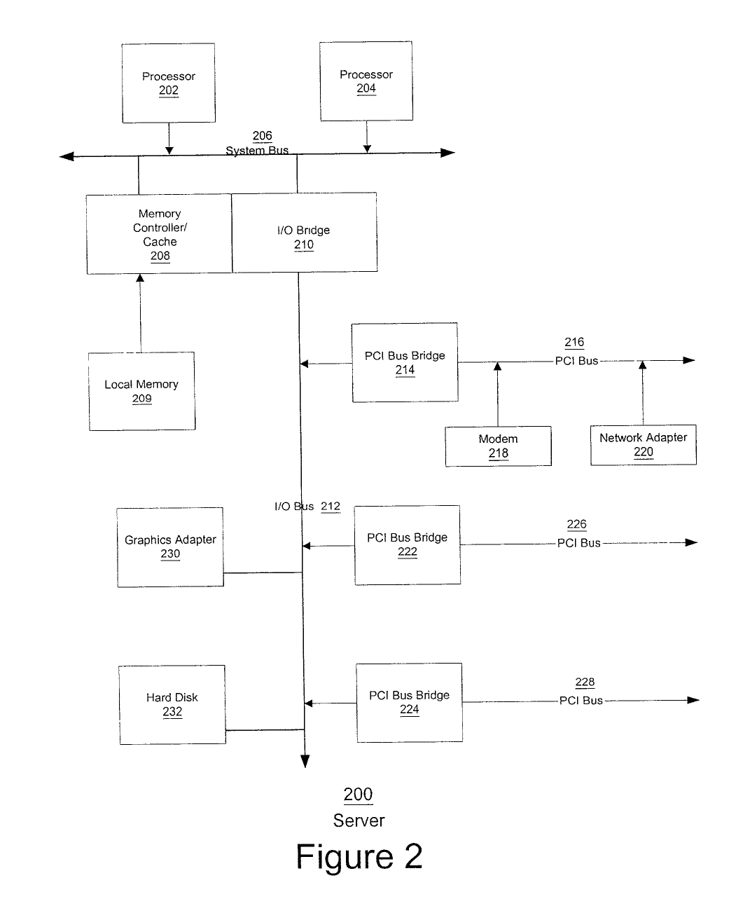

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

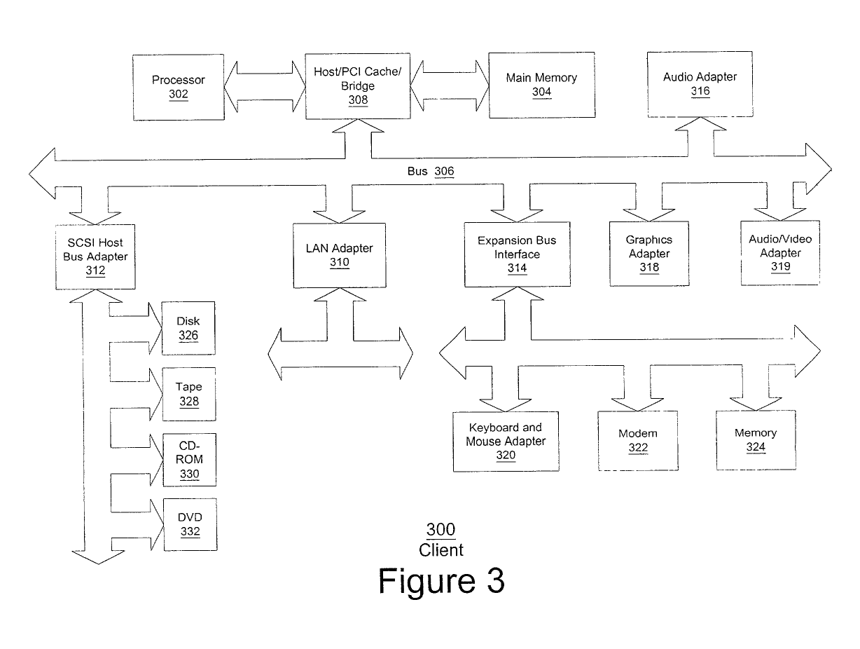

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present uses the Lightweight Directory Access Protocol (LDAP) technology to centralize storage and retrieval of user passwords. LDAP is suitable for distributed security authentication, because it provides a ready made client-server implementation. A cluster authentication system can be devised simply by making LDAP client API calls from the security routines to store and retrieve data. Therefore, LDAP is well suited for the storing and retrieving users' passwords from a central database.

In order to achieve the design goal, each user within an organizational unit is added and stored in, for example, LDAP DB/2 backend as an entry. Each user/entry could have the following attributes:

| | |
|---|---|
| Full Name | (single-value attribute) |
| Common Name | (single-value attribute) |
| Social Security | (binary single-value attribute) |
| Serial Number | (single-value attribute) |
| E-mail | (multiple-value attribute) |
| UserID | (single-value attribute) |
| Password | (binary single-value attribute) |
| Others | |

In one embodiment, instead of having multiple password attributes to store multiple passwords for different applications, the process is simplified by having only one password attribute. The password attribute's value is set to a referral object where all passwords and associated applications for the user are stored. For example, this can be performed with ref attribute as follows:

dn: ou=Austin, o=IBM, c=US

objectclass: referral

ret: ldap://<host>:<port>/ou=Austin, o=IBM, c=US

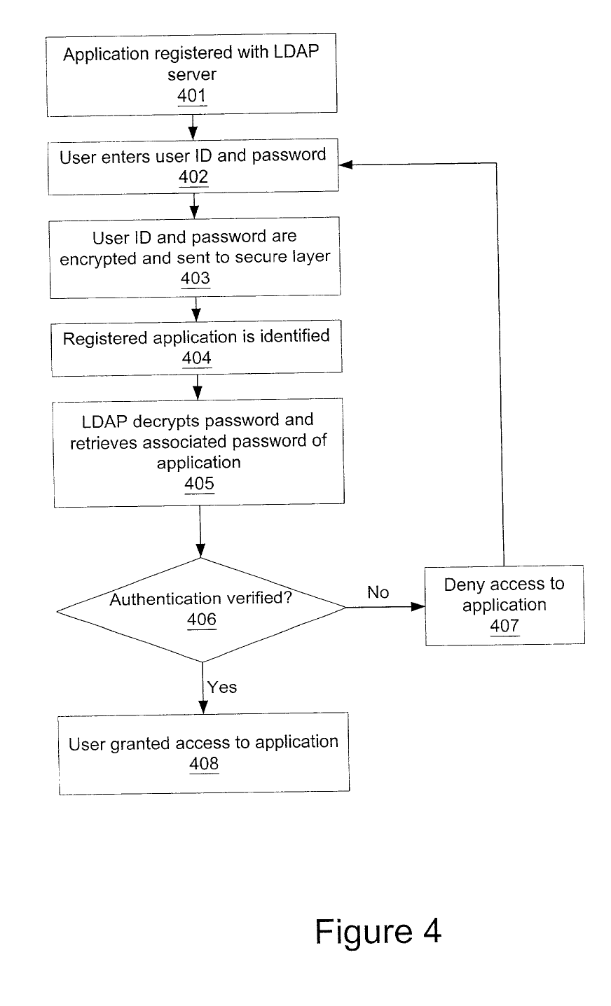

Referring to FIG. 4, a flowchart illustrating the authentication of application passwords is depicted in accordance with the present invention. Each application needs to register with the LDAP server to identify its associated password, so that the server knows what kind of password it needs to retrieve (i.e. CMVC, Lotus, VM, Unix System, etc.) (step 401). The present invention will improve the performance of the password search. Accessing only one central database will reduce the delay caused by the network, the wait from multiple sources accessing the same database, and the I/O execution time required by multiple databases. In another embodiment, if the password is stored as a multiple-value attribute, the provided password will be compared against all passwords to determine the right to access the desired application.

Once the userID and password are supplied from the application login panel (step 402), the information will be encrypted and transferred to a secure layer (step 403) where the registered application will be identified (step 404) before the information is passed to the LDAP server. The LDAP server must decrypt the password and retrieve the associated password of the application (step 405) and then sends this information to security service to perform the authentication (step 406).

The LDAP server sends back a response to the application with an indication as to whether or not an authentication has been verified. If authentication has not been verified, access to the application is denied (step 407) and the user must enter another user ID and/or password (step 402). If authentication is verified, the user may access the application (step 408).

The present invention could also be extended to help network administrators to easily manage and control user accounts. In a large organization, each user usually has more than one account. For example, a user may have one account for email, one for 401K, one for Unix system, one for PC, etc. With the present invention, rather than modifying several separate accounts for each user, a single LDAP command can easily modify, add, or delete an entry from the Central Database.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for central storage and retrieval of user passwords in a computer network, comprising:
entering network user ID and password information into a central database;
registering network applications and their associated passwords with a LDAP server;
receiving user ID and password data from an application login;
identifying the registered application and sending the user ID and password to the LDAP server;
retrieving the application's associated password;
authenticating the user password;
sending a response from the LDAP server back to the application; and
granting access to the application only if the authentication is verified.

2. The method according to claim 1, wherein the step of receiving a user ID and password from an application login further comprises:
encrypting the user ID and password and sending them to a secure layer before the application is identified; and
decrypting the user password in the LDAP server before retrieving the application's password.

3. The method according to claim 1, further comprising, if authentication is not verified, allowing the user to submit a new user ID and password.

4. The method according to claim 1, further comprising setting one password attribute, wherein the value of the password attribute is set to a referral object where all passwords and associated applications for the user are stored.

5. The method according to claim 1, further comprising:
storing the application password as a multiple-value attribute; and
comparing the password provided by the user against all passwords to determine the right to access the desired application.

6. The method according to claim 1, further comprising using a single LDAP command to modify and manage all of a network user's accounts.

7. A computer program product in a computer readable medium for use in a data processing system, for central storage and retrieval of user passwords in a computer network, the computer program product comprising:
instructions for entering network user ID and password information into a central database;
instructions for registering network applications and their associated passwords with a LDAP server;
instructions for receiving user ID and password data from an application login;
instructions for identifying the registered application and sending the user ID and password to the LDAP server;
instructions for retrieving the application's associated password;
instructions for authenticating the user password;
instructions for sending a response from the LDAP server back to the application; and
instructions for granting access to the application only if the authentication is verified.

8. The computer program product according to claim 7, wherein the instructions for receiving a user ID and password from an application login further comprises:
instructions for encrypting the user ID and password and sending them to a secure layer before the application is identified; and
instructions for decrypting the user password in the LDAP server before retrieving the application's password.

9. The computer program product according to claim 7, further comprising, if authentication is not verified, instructions for allowing the user to submit a new user ID and password.

10. The computer program product according to claim 7, further comprising instructions for setting one password attribute, wherein the value of the password attribute is set to a referral object where all passwords and associated applications for the user are stored.

11. The computer program product according to claim 7, further comprising:
instructions for storing the application password as a multiple-value attribute; and
instructions for comparing the password provided by the user against all passwords to determine the right to access the desired application.

12. The computer program product according to claim 7, further comprising instructions for using a single LDAP command to modify and manage all of a network user's accounts.

13. A system for central storage and retrieval of user passwords in a computer network, comprising:
means for entering network user ID and password information into a central database;
means for registering network applications and their associated passwords with a LDAP server;
means for receiving user ID and password data from an application login;
means for identifying the registered application and sending the user ID and password to the LDAP server;
means for retrieving the application's associated password;
means for authenticating the user password;
means for sending a response from the LDAP server back to the application; and
means for granting access to the application only if the authentication is verified.

14. The system according to claim 13, wherein the means for receiving a user ID and password from an application login further comprises:
means for encrypting the user ID and password and sending them to a secure layer before the application is identified; and
means for decrypting the user password in the LDAP server before retrieving the application's password.

15. The system according to claim 13, further comprising, if authentication is not verified, means for allowing the user to submit a new user ID and password.

16. The system according to claim 13, further comprising means for setting one password attribute, wherein the value of the password attribute is set to a referral object where all passwords and associated applications for the user are stored.

17. The system according to claim 13, further comprising:
means for storing the application password as a multiple-value attribute; and
means for comparing the password provided by the user against all passwords to determine the right to access the desired application.

18. The system according to claim 13, further comprising means for using a single LDAP command to modify and manage all of a network user's accounts.
